(19) United States
(12) Patent Application Publication
(10) Pub. No.: US 2010/0201870 A1
(43) Pub. Date: Aug. 12, 2010

(54) System and method for frame interpolation for a compressed video bitstream

(76) Inventors: Martin Luessi, Pfaeffikon (CH); Aggelos Katsaggelos, Evanston, IL (US); Dusan Veselinovic, Park Ridge, IL (US); Krisda Lengwehasatit, Chiangmai (TH); James J. Kosmach, Geneva, IL (US)

Correspondence Address: PATENTS+TMS, P.C., 2849 W. ARMITAGE AVE., CHICAGO, IL, 60647, US

(21) Appl. No.: 12/658,470

(22) Filed: Feb. 9, 2010

Related U.S. Application Data
(60) Provisional application No. 61/207,381, filed on Feb. 11, 2009.

(51) Int. Cl. H04N 7/01

(52) U.S. Cl. 348/452; 348/E07.003

(57) ABSTRACT

A system and a method perform frame interpolation for a compressed video bitstream. The system and the method may combine candidate pictures to generate an interpolated video picture inserted between two original video pictures. The system and the method may generate the candidate pictures from different motion fields. The candidate pictures may be generated partially or wholly from motion vectors extracted from the compressed video bitstream. The system and the method may reduce computation required for interpolation of video frames without a negative impact on visual quality of a video sequence.

This application claims the benefit of U.S. Provisional Application Ser. No. 61/207,381, filed Feb. 11, 2009.

### BACKGROUND OF THE INVENTION

The present invention generally relates to a system and a method for frame interpolation for a compressed video bitstream. More specifically, the present invention relates to a system and a method that combine candidate pictures to generate an interpolated video picture inserted between two original video pictures. The system and the method may generate the candidate pictures from different motion fields. The candidate pictures may be generated partially or wholly from motion vectors extracted from the compressed video bitstream. The system and the method may reduce computation required for interpolation of video frames without a negative impact on visual quality of a video sequence.

It is well known to utilize video compression to reduce a size of video data transmitted from a first location to a second location. A video encoder at the first location generates an encoded representation of the video data. The video encoder produces an encoded video bitstream which may be transmitted to the second location. A video decoder decodes the encoded video bitstream to recover the video data for rendering and viewing by a user.

Video compression typically uses a technique known as “lossy encoding” which may provide compressed files of small size relative to a size of the original video data. However, the “lossy encoding” technique causes loss of some of the video data. Thus, use of the “lossy encoding” technique may result in visible degradation of visual quality, loss of spatial resolution of video frames and/or a reduced number of video frames displayed per second. The number of video frames displayed per second is known as temporal resolution. In a typical example of known video compression techniques, the original video data may have VGA resolution, namely 640 pixels wide by 480 pixels high, and may have a temporal resolution of thirty frames per second. The video data recovered from the compressed video bitstream may have a lower resolution, such as QVGA resolution, namely 320 pixels wide by 240 pixels high, and may have a lower temporal resolution of fifteen frames per second. Thus, the video data that is decoded and displayed after the video compression has a lower visual quality relative to the original uncompressed video data.

Although the video data that is decoded and displayed may have a lower temporal resolution relative to the original video data, prediction of frames lost in the encoding and decoding process may compensate for the lower temporal resolution. Decoded video frames may be used to predict the frames lost in the encoding and decoding process. Use of the decoded video frames to predict the frames lost in the encoding and decoding process is generally known as video frame rate upconversion (hereinafter “upconversion”). Upconversion techniques often utilize motion compensation to predict contents of the frames lost in the encoding and decoding process.

The upconversion is employed to improve the visual quality of video sequences having low temporal resolution. For mobile devices, a common scenario is an upconversion that doubles the temporal resolution from fifteen frames per second to thirty frames per second. A low temporal resolution of fifteen frames per second is often used to reduce a bitrate of the compressed video sequence. The reduced bitrate may reduce a bandwidth necessary for transmitting the video data and/or may allow more channels in broadcast scenarios, such as, for example, Digital Video Broadcasting-Handheld mobile TV format (“DVB-H”). Increasing the temporal resolution using upconversion by a display device may increase smoothness of motion in the video sequence which may result in an improved visual quality for the video sequence.

A doubled temporal resolution of an upconverted video sequence may be achieved in upconversion by inserting a temporally interpolated frame fₙ between each pair of consecutive original frames fₙ₋₁, fₙ₊₁. Insertion of temporally interpolated frames is generally illustrated in FIG. 1 where the even-numbered frames are original frames and the odd-numbered frames are temporally interpolated frames. Hereafter, “interpolated frame fₙ” and hatted symbol f̂ₙ are used interchangeably. Both the “interpolated frame fₙ” and the hatted symbol f̂ₙ represent the interpolated image.

An upconversion system must perform motion estimation followed by motion compensation to generate the temporally interpolated frames which may be inserted between the original frames. The temporally interpolated frames may be inserted between the decoded frames recovered from the compressed bitstream during display of the associated video sequence.

Motion estimates may be unreliable for upconversion techniques that utilize motion compensation to predict contents of the lost frames. For example, the motion estimates may be unreliable due to fast or complex motion, uncovered or occluded areas and/or the like. The unreliable motion estimates may introduce visible artifacts which may degrade visual quality of the upconverted video sequence.

In addition, the motion estimation may be challenging for mobile devices. Since computational resources on a mobile device are scarce, the motion estimation and the motion compensation must be limited in computational complexity. Limitations on the computational complexity of the motion estimation and the motion compensation may prevent production of dense motion field estimates that provide high visual quality for the temporally interpolated frames. Instead, computationally limited mobile devices typically utilize a block-based motion estimation method that requires a small number of block matching operations. Therefore, the motion estimation has a relatively low computational complexity. A disadvantage of the block-based motion estimation method is that the method has limited capabilities and may provide erroneous motion estimates that may introduce visible artifacts into the temporally interpolated frames. As discussed previously, visible artifacts located in the temporally interpolated frames degrade the visual quality of the upconverted video sequence. The visual quality of the upconverted video sequence may appear visually less appealing than the original video sequence and may have a lower temporal resolution than the original video sequence. Thus, the computational limitations inherent to mobile devices reduce effectiveness of the upconversion performed by mobile devices.

To mitigate effects of the unreliable motion estimates, some upconversion systems estimate the visual quality of the temporally interpolated frames and may suspend interpolation if the visual quality is determined insufficient. For example, some upconversion systems utilize frame repetition if the estimated visual quality of the temporally interpolated frame is less than a predetermined threshold. The frame repetition may be global in that a previously decoded frame is repeated instead of displaying a temporally interpolated frame having insufficient visual quality. Alternatively, the frame repetition may be local in that a portion of the previously decoded frame is repeated to cover an area of the temporally interpolated frame having insufficient visual quality. United States Patent Application Publication No. 2006/0045365 by de Haan et al. discloses a system of frame repetition if the estimated visual quality of the temporally interpolated frames is less than a predetermined threshold.

However, accurately estimating the visual quality of the temporally interpolated frames may be difficult since the original frames replaced by the temporally interpolated frames are not available. For example, in the video compression scenario, the original frames have typically been discarded by the video encoder. Thus, the original frames are not available to the decoder that performs the upconversion. Existing methods estimate the visual quality of the temporally interpolated frames based on the smoothness of the motion field.

However, problems exist with estimating the visual quality of the temporally interpolated frames based on the smoothness of the motion field. For example, the motion field may be “noisy” and/or may exhibit randomness within regions of uniform luminance. As a further example, the motion field may exhibit structured discontinuities at motion object boundaries. A visual quality estimation technique based on the smoothness of the motion field may suggest an unsatisfactory visual quality of the temporally interpolated frame in each of these examples; however, the non-uniformities in these examples may be harmless in that they may not correspond to poor visual quality in the temporally interpolated frame. The unreliable estimates of the visual quality of temporally interpolated frames may cause the system to suspend the interpolation even if the temporally interpolated frames actually have sufficient visual quality. Suspension of the interpolation if the temporally interpolated frames have sufficient visual quality reduces effectiveness of the upconversion and degrades the visual quality of the upconverted video sequence.

A need, therefore, exists for a system and a method for frame interpolation for a compressed video bitstream. Further, a need exists for a system and a method for frame interpolation for a compressed video bitstream that combine candidate pictures to generate an interpolated video frame inserted between two original video frames. Still further, a need exists for a system and a method for frame interpolation for a compressed video bitstream that combine candidate interpolation pictures generated from different motion fields. Still further, a need exists for a system and a method for frame interpolation for a compressed video bitstream that utilize different motion fields computed using complementary techniques. Still further, a need exists for a system and a method for frame interpolation for a compressed video bitstream that generate candidate interpolation pictures using motion vectors extracted from the compressed video bitstream. Still further, a need exists for a system and a method for frame interpolation for a compressed video bitstream that reduce computation required for upconversion without a negative impact on the visual quality of the video sequence. Still further, a need exists for a system and a method for frame interpolation for a compressed video bitstream that perform efficient upconversion using a mobile device having limited processing power. Moreover, a need exists for a system and a method for frame interpolation for a compressed video bitstream that provide visual quality estimates which are more accurate than those of known upconversion systems.

### SUMMARY OF THE INVENTION

The present invention generally relates to a system and a method for frame interpolation for a compressed video bitstream. More specifically, the present invention relates to a system and a method that combine candidate pictures to generate an interpolated video picture inserted between two original video frames. The system and the method may generate the candidate pictures from different motion fields computed using complementary techniques. The candidate pictures may be generated partially or wholly from motion vectors extracted from a compressed video bitstream. The system and the method may implement a visual quality estimation method based on sum of absolute difference (“SAD”) operations. The system and the method may reduce computation required for interpolation of video frames without a negative impact on the visual quality of a video sequence. The system and the method may perform efficient upconversion using a mobile device having limited processing power.

To this end, in an embodiment of the present invention, a method for frame interpolation for a bitstream encoding a first source image and a second source image which is encoded subsequent to the first source image is provided. A device receives the bitstream. The method has the steps of decoding the first source image and the second source image from the bitstream; performing a first motion estimation which uses the first source image and the second source image to create a first motion field wherein the first source image is a reference grid for the first motion estimation; performing a first motion compensation which uses the first motion field to create a forward candidate interpolation picture; performing a second motion estimation which uses the first source image and the second source image to create a second motion field which is a different motion field than the first motion field wherein the second source image is a reference grid for the second motion estimation; performing a second motion compensation which uses the second motion field to create a backward candidate interpolation picture; performing a third motion estimation which uses the first source image and the second source image to create a third motion field which is a different motion field than the first motion field and the second motion field wherein a bidirectional candidate interpolation picture is a reference grid for the third motion estimation; performing a third motion compensation which uses the third motion field to create the bidirectional candidate interpolation picture; determining an estimated visual quality of a final interpolated picture formed by a combination of the forward candidate interpolation picture, the backward candidate interpolation picture and the bidirectional candidate interpolation picture; and displaying the final interpolated picture if the estimated visual quality exceeds a threshold.

In an embodiment, the method has the step of applying a first sum of absolute difference operation to the forward candidate interpolation picture and the backward candidate interpolation picture, a second sum of absolute difference operation to the forward candidate interpolation picture and the bidirectional candidate interpolation picture, and a third sum of absolute difference operation to the backward candidate interpolation picture and the bidirectional candidate interpolation picture wherein results of the first sum of absolute difference operation, the second sum of absolute difference operation and the third sum of absolute difference operation are used to determine the estimated visual quality of the final interpolated picture.

In an embodiment, the method has the step of performing a median filtering operation for the forward candidate interpolation picture, the backward candidate interpolation picture and the bidirectional candidate interpolation picture wherein the median filtering operation combines the forward candidate interpolation picture, the backward candidate interpolation picture and the bidirectional candidate interpolation picture to produce the final interpolated picture.

In an embodiment, the method has the step of determining an estimated number of blocks in the final interpolated picture which are likely to have motion artifacts wherein the estimated number of blocks in the final interpolated picture which are likely to have motion artifacts is determined without combining the forward candidate interpolation picture, the backward candidate interpolation picture and the bidirectional candidate interpolation picture to produce the final interpolated picture and further wherein the estimated visual quality of the final interpolated picture is based on the estimated number of blocks in the final interpolated picture which are likely to have motion artifacts.

In an embodiment, at least one of the first motion estimation, the second motion estimation and the third motion estimation use enhanced predictive zonal search motion estimation.

In an embodiment, the method has the step of performing overlapped block motion compensation to at least one of the forward candidate interpolation picture, the backward candidate interpolation picture and the bidirectional candidate interpolation picture wherein the overlapped block motion compensation is performed in a corresponding one of the first motion compensation, the second motion compensation and the third motion compensation.

In an embodiment, the method has the step of using parameters encoded by the bitstream to determine whether to use motion vectors encoded by the bitstream in the first motion estimation and the second motion estimation for a block of one of the first source image and the second source image.

In an embodiment, the method has the step of using information encoded by the bitstream to determine whether to split a 16×16 block of one of the first source image and the second source image into smaller blocks for at least one of the first motion estimation, the second motion estimation and the third motion estimation wherein each of the smaller blocks is associated with a motion vector.

In an embodiment, the method has the step of using an estimate of a number of blocks of the final interpolated picture which are likely to have motion artifacts to determine a presence of a scene change wherein the forward candidate interpolation picture, the backward candidate interpolation picture and the bidirectional candidate interpolation picture are not combined to form the final interpolated picture if the presence of the scene change is determined.

In an embodiment, the method has the step of using frame repetition to extend display of the first source image before displaying the second source image if the estimated visual quality is below the threshold wherein the forward candidate interpolation picture, the backward candidate interpolation picture and the bidirectional candidate interpolation picture are not combined to form the final interpolated picture if the estimated visual quality is below the threshold.

In an embodiment, the method has the step of resetting at least one of the first motion field, the second motion field and the third motion field with zero motion vectors if an estimated number of blocks in the final interpolated picture which are likely to have motion artifacts does not meet a predetermined value.

In an embodiment, the method has the step of rotating at least one of the first motion field, the second motion field and the third motion field wherein rotating the at least one of the first motion field, the second motion field and the third motion field causes a current motion field to become a previous motion field and further wherein the first motion estimation, the first motion compensation, the second motion estimation, the second motion compensation, the third motion estimation and the third motion compensation are repeated using the motion fields which are rotated, the second source image and a third source image which is encoded subsequent to the second source image in the bitstream.

In an embodiment, the method has the step of performing chroma channel motion compensation on the final interpolated picture using the first motion field, the second motion field and the third motion field.

In another embodiment of the present invention, a method for frame interpolation for a bitstream encoding a first source image and a second source image subsequent to the first source image is provided. The first source image and the second source image are formed by macroblocks. Motion vectors are encoded by the bitstream, and each of the macroblocks is associated with at least one of the motion vectors. The bitstream encodes block mode information, and a device receives the bitstream. The method has the steps of determining reliable motion vectors of the motion vectors encoded by the bitstream wherein the motion vectors and the block mode information are used to determine the reliable motion vectors; performing a first motion estimation which uses the first source image and the second source image to create a first motion field wherein the first source image is a reference grid for the first motion estimation and further wherein the first motion estimation uses the reliable motion vectors; performing a first motion compensation which uses the first motion field to create a forward candidate interpolation picture; performing a second motion estimation which uses the first source image and the second source image to create a second motion field which is a different motion field than the first motion field wherein the second source image is a reference grid for the second motion estimation and further wherein the second motion estimation uses the reliable motion vectors; performing a second motion compensation which uses the second motion field to create a backward candidate interpolation picture; performing a third motion estimation which uses the first source image and the second source image to create a third motion field which is a different motion field than the first motion field and the second motion field wherein a bidirectional candidate interpolation picture is a reference grid for the third motion estimation; performing a third motion compensation which uses the third motion field to create the bidirectional candidate interpolation picture; and displaying the first source image, the second source image and an interim image wherein the interim image is displayed after the first source image and before the second source image.

In an embodiment, the method has the steps of determining an estimated number of blocks in a final interpolated picture which are likely to have motion artifacts wherein the final interpolated picture is a combination of the forward candidate interpolation picture, the backward candidate interpolation picture, and the bidirectional candidate interpolation picture and further wherein the estimated number of blocks which are likely to have motion artifacts is determined without combining the forward candidate interpolation picture, the backward candidate interpolation picture, and the bidirectional candidate interpolation picture to produce the final interpolated picture; identifying one of the final interpolated picture and a frame repetition of the first source image to use as the interim image wherein identification is based on the estimated number of blocks in the final interpolated picture which are likely to have the motion artifacts; and forming the interim image wherein the interim image is formed using median filtering to combine the forward candidate interpolation picture, the backward candidate interpolation picture and the bidirectional candidate interpolation picture if the final interpolated picture is identified for use as the interim image and further wherein the interim image is formed using the frame repetition of the first source image if the frame repetition of the first source image is identified for use as the interim image.

In an embodiment, the method has the step of determining whether to split blocks used in the first motion estimation and the second motion estimation into smaller blocks based on the block mode information encoded by the bitstream wherein each of the smaller blocks is associated with at least one of the motion vectors and further wherein the smaller blocks correspond to areas of increased density of the first motion field and the second motion field.

In an embodiment, the bitstream is a H.264 compressed video bitstream.

In another embodiment of the present invention, a system for frame interpolation for a bitstream encoding a first source image and a second source image is provided. The system has a mobile device which receives the bitstream; a processor connected to the mobile device which decodes the first source image and the second source image from the bitstream; and an application executed by the mobile device which directs the processor to use the first source image and the second source image to generate at least three candidate interpolation pictures wherein the processor applies a sum of absolute difference operation to the at least three candidate interpolation pictures to estimate a number of blocks which are likely to have motion artifacts in a final interpolated picture formed by the at least three candidate interpolation pictures.

In an embodiment, the processor uses the number of blocks which are likely to have motion artifacts to determine a presence of a scene change between the first source image and the second source image and further wherein the processor does not form the final interpolated picture if the processor determines the presence of the scene change wherein the mobile device uses frame repetition in displaying the first source image before the second source image if the processor determines the presence of the scene change.

In an embodiment, the processor uses the number of blocks which are likely to have motion artifacts to estimate a visual quality of the final interpolated picture and further wherein the processor forms the final interpolated picture from the at least three candidate interpolation pictures if the visual quality estimated meets a threshold wherein the mobile device displays the first source image, the final interpolated picture and the second source image.

In an embodiment, the processor uses the number of blocks which are likely to have motion artifacts to estimate a visual quality of the final interpolated picture and further wherein the processor does not form the final interpolated picture if the visual quality estimated does not meet a threshold wherein the mobile device uses frame repetition to extend display of the first source image before displaying the second source image if the visual quality estimated does not meet the threshold.

It is, therefore, an advantage of the present invention to provide a system and a method for frame interpolation for a compressed video bitstream.

Another advantage of the present invention is to provide a system and a method that combine motion compensated interpolations from a forward interpolation path, a backward interpolation path and/or a bi-directional interpolation path using a median filter.

And, another advantage of the present invention is to provide a system and a method that test reliability of motion vectors obtained from the bitstream without using block matching operations.

Yet another advantage of the present invention is to provide a system and a method that split a subset of blocks to improve interpolation quality in areas of complex local motion while maintaining a size of blocks where local motion is not complex.

Still further, an advantage of the present invention is to provide a system and a method that perform a blockwise artifact count estimation using SAD operations applied to three candidate interpolation pictures.

And, another advantage of the present invention is to provide a system and a method that reduce computation required for interpolation of video frames without a negative impact on visual quality of a video sequence.

Moreover, an advantage of the present invention is to provide a system and a method that perform efficient upconversion using a mobile device having limited processing power.

Additional features and advantages of the present invention are described in, and will be apparent from, the detailed description of the presently preferred embodiments and from the drawings.

### BRIEF DESCRIPTION OF THE DRAWINGS

FIG. 1 illustrates a prior art system for interpolation.

FIG. 2 illustrates a block diagram of a method for frame interpolation for a compressed video bitstream in an embodiment of the present invention.

FIG. 3 illustrates a flowchart of a method for frame interpolation for a compressed video bitstream in an embodiment of the present invention.

FIG. 4 illustrates a table of modes of operation for a system and a method for frame interpolation for a compressed video bitstream in an embodiment of the present invention.

FIG. 5 illustrates a diagram of bidirectional interpolation in an embodiment of the present invention.

FIG. 6 illustrates a diagram of unidirectional interpolation in an embodiment of the present invention.

FIG. 7 illustrates a reference grid in an embodiment of the present invention.

FIG. 8 illustrates a reference grid in an embodiment of the present invention.

FIG. 9 illustrates a EPZS small diamond pattern in an embodiment of the present invention.

FIG. 10 illustrates macroblock partitions in an embodiment of the present invention.

FIG. 11 illustrates motion vectors provided by the bitstream in an embodiment of the present invention.

FIG. 12 illustrates motion vector interpolation in an embodiment of the present invention.

### DETAILED DESCRIPTION OF THE PREFERRED EMBODIMENTS

The present invention generally relates to a system and a method for frame interpolation for a compressed video bitstream. More specifically, the present invention relates to a system and a method for frame interpolation for a compressed video bitstream that combine candidate frames to generate an interpolated frame inserted between two original video frames. The system and the method for frame interpolation for a compressed video bitstream may employ three interpolation paths, namely a bidirectional interpolation path, a forward interpolation path and a backward interpolation path.

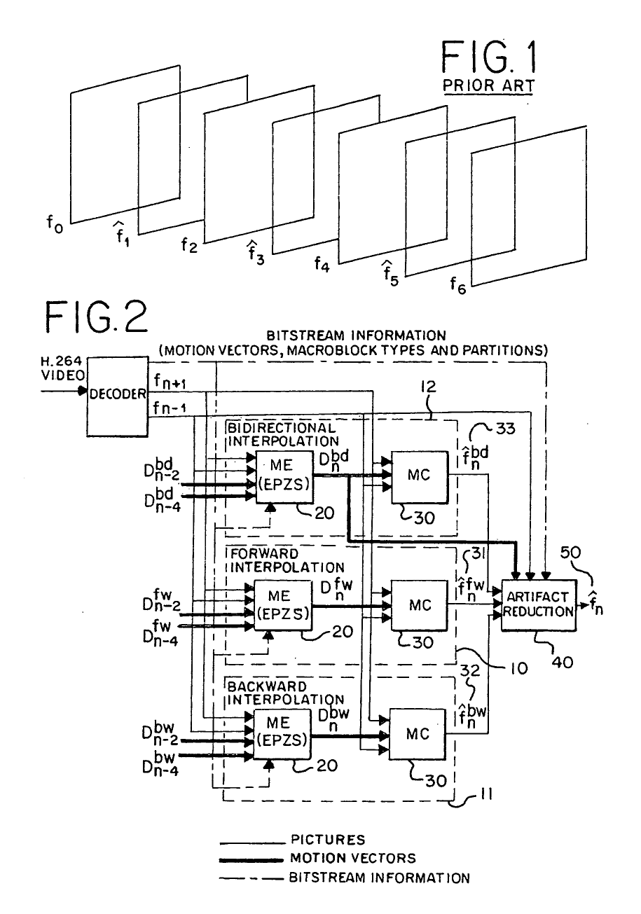

Referring now to the drawings wherein like numerals refer to like parts, FIG. 2 generally illustrates an embodiment of a method 9 for frame interpolation for a compressed video bitstream. A system and/or the method 9 may utilize a forward interpolation path 10, a backward interpolation path 11 and a bidirectional interpolation path 12 (collectively hereinafter “the interpolation paths 10-12”). The interpolation paths 10-12 may perform motion estimation steps 20 and/or motion compensation steps 30 to create a candidate interpolation picture corresponding to the interpolation path that generated the candidate interpolation picture. Each of the interpolation paths 10-12 may use a different motion vector direction and/or a different reference grid of motion vectors to produce a different candidate interpolation picture. The system and/or the method 9 may combine the resulting candidate interpolation pictures to produce a final interpolated picture 50 using median filtering in an artifact reduction step 40 as described hereafter.

For example, the forward interpolation path 10, the backward interpolation path 11 and/or the bidirectional interpolation path 12 may perform the motion estimation steps 20 and/or the motion compensation steps 30 to create a forward candidate interpolation picture 31, a backward candidate interpolation picture 32 and/or a bidirectional candidate interpolation picture 33. The system and/or the method 9 may combine the forward candidate interpolation picture 31, the backward candidate interpolation picture 32 and/or the bidirectional candidate interpolation picture 33 to produce the final interpolated picture 50 using the median filtering in the artifact reduction step 40.

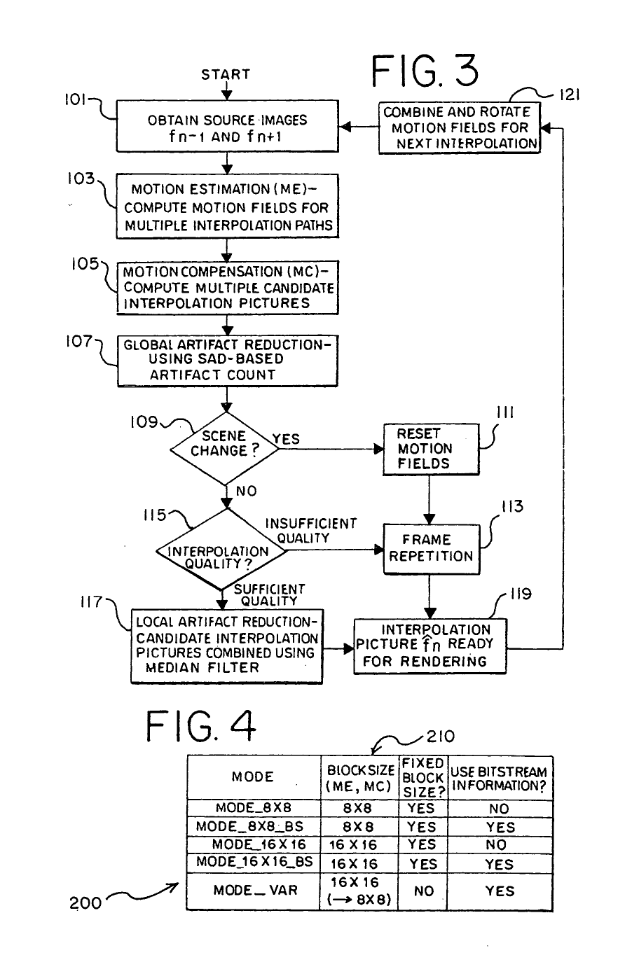

FIG. 3 generally illustrates an embodiment of the method 9 for frame interpolation for a compressed video bitstream. As generally illustrated at step 101, the system and/or the method 9 may obtain source images fₙ₋₁ and fₙ₊₁ from which an interpolated frame fₙ may be generated. In a preferred embodiment, the system may decode the source images from a compressed video bitstream. The present invention may obtain the source images fₙ₋₁ and fₙ₊₁ by any means known to one skilled in the art.

After the source images are available, the system may perform motion estimation as generally shown at step 103. The motion estimation may generate multiple motion fields corresponding to multiple different motion interpolation paths. In a preferred embodiment, the motion estimation may employ Enhanced Predictive Zonal Search (“EPZS”) motion estimation as well-known in the art. However, other motion estimation techniques are well known, and the motion estimation may be performed using any motion estimation technique which produces motion vectors for motion blocks known to one skilled in the art.

The motion estimation may use motion vectors present in an available compressed video bitstream (“the bitstream”). The motion vectors present in the bitstream may enable the motion estimation to proceed without performing a motion vector search to discover suitable motion vectors. Thus, use of the motion vectors present in the bitstream may reduce computational complexity of the motion estimation. Parameters provided by the bitstream may enable determination of whether the motion vectors present in the bitstream may be suitable for use in the motion estimation for a specific block. The system and/or the method 9 may utilize the motion vectors present in the bitstream before the motion estimation is performed for a current block of the bitstream. Thus, determination of whether to use the motion vectors for a block of the bitstream may be performed regardless of the motion estimation technique employed.

The system and/or the method 9 may utilize the parameters provided by the bitstream to determine whether a block of the bitstream should be split into smaller blocks. Larger motion blocks which may require less computation for the motion estimation may be used if such motion blocks enable sufficient capture of local motion. Smaller motion blocks which may require additional computation for the motion estimation may be used if the local motion is complex. The system may use and/or may adapt the parameters provided by the bitstream to determine whether the block should be split into smaller blocks without the need to perform complex computations, such as, for example, SAD computations.

The motion estimation may produce at least three candidate motion fields which may correspond to the interpolation paths 10-12. The motion estimation may produce a first candidate motion field which may correspond to the forward interpolation path 10, a second candidate motion field which may correspond to the backward interpolation path 11, and/or a third candidate motion field which may correspond to the bidirectional interpolation path 12. Each of the candidate motion fields may be used to generate a corresponding candidate interpolation picture in the motion compensation as generally shown at step 105.

Then, the system and/or the method 9 may employ global artifact reduction as generally shown at step 107. The system may employ the global artifact reduction to determine whether the candidate interpolation pictures are likely to combine to produce a final interpolated picture of sufficient visual quality. The global artifact reduction may involve an artifact counting method which may employ blockwise SAD comparisons between pairs of candidate interpolation pictures. The blockwise SAD comparisons may provide an estimate of a number of blocks and/or a fraction of blocks in the final interpolated picture which are likely to have motion artifacts. The blockwise SAD comparisons may provide more accurate results relative to measurements of interpolation quality based on measuring smoothness of the estimated motion field.

The system and/or the method 9 may utilize the estimate of the number of blocks and/or the fraction of blocks in the final interpolated picture which are likely to have motion artifacts calculated by the global artifact reduction to determine a presence of scene changes in the original sequence of source images. The system and/or the method 9 may combine the estimate with the parameters from the bitstream to determine the presence of the scene changes as generally shown at step 109. If the system and/or the method 9 detects a scene change, the system and/or the method 9 may reset the motion fields used for prediction in the motion estimation search as generally illustrated at step 111. Further, as generally shown at step 113, if the system and/or the method 9 detects a scene change, the system and/or the method 9 may implement frame repetition because an interpolated image may not be used during a scene change. Moreover, if the system and/or the method 9 detects a scene change, the system and/or the method 9 may not perform combination of the candidate interpolation pictures to avoid computation associated with the combination of the candidate interpolation pictures.

As generally shown at step 115, if a scene change is not present, the system and/or the method 9 may use the estimate of the number of blocks and/or the fraction of blocks in the final interpolated picture which are likely to have motion artifacts to determine whether the visual quality of the final interpolated picture is likely to be sufficient for display. The determination of sufficiency of visual quality may involve an estimate of global motion, such as, for example, camera panning. For example, a higher estimate of the number of blocks and/or the fraction of blocks in the final interpolated picture which are likely to have motion artifacts may be allowable for display if the estimate of global motion is also high. If the system and/or the method 9 determine that the visual quality of the final interpolated picture is insufficient for display, the system and/or the method 9 may implement frame repetition as generally shown at step 113. Implementation of frame repetition may enable the system and/or the method 9 to not perform combination of the candidate interpolation pictures to avoid computation associated with the combination of the candidate interpolation pictures.

If a scene change is not present and the visual quality of the final interpolated picture is determined to be sufficient for display, the system and/or the method 9 may combine the candidate interpolation pictures using local artifact reduction as generally shown at step 117. The local artifact reduction may involve a median filtering operation that may use multiple candidate interpolation pictures from multiple estimated motion fields. The multiple estimated motion fields may be the forward interpolation path 10, the backward interpolation path 11 and/or the bi-directional interpolation path 12. Use of at least three candidate interpolation pictures may provide better interpolation performance than median-filtering based combinations known to one skilled in the art.

Chroma channels may define color hue in display of the video sequence. The local artifact reduction may use motion compensated interpolation for the chroma channels. In a preferred embodiment, the system and/or the method 9 may perform motion compensated interpolation for the chroma channels after combination of the candidate interpolation pictures. Thus, the system and/or the method 9 may not need to perform the motion compensated interpolation for the chroma channels separately for each of the candidate interpolation images. Further, performance of the motion compensated interpolation for the chroma channels after the combination of the candidate interpolation pictures may be advantageous in that the system and/or the method 9 may not need to perform the motion compensated interpolation for the chroma channels if the system and/or the method 9 implement the frame repetition.

If the system and/or the method 9 generate the final interpolated picture fₙ and/or implement the frame repetition of the interpolated picture fₙ=fₙ₋₁, the system and/or the method 9 may provide the final interpolated picture for rendering as generally shown at step 119. The present invention is not limited to a specific means of rendering the final interpolated picture.

The system and/or the method 9 may prepare for the creation of the next interpolation picture by combining the motion fields which are to be used as prediction input for the motion estimation of the next interpolation picture, as generally shown at step 121. Further, the system and/or the method 9 may rotate motion field arrays to align the stored motion fields in time as generally shown at step 121. The system and/or the method 9 may incrementally increase a frame index from n to n+2 and/or may repeat interpolation to produce the next interpolation picture.

The system and/or the method 9 may have different modes of operation as generally illustrated by table 200 in FIG. 4. A block size indicated in column 210 may denote a dimension of blocks in pixels that may be used for the motion estimation and/or the motion compensation. For fixed block sizes, the system and/or the method 9 may be configured to use information from the bitstream. Alternatively, for fixed block sizes, the system and/or the method 9 may be configured to not use the information from the bitstream. If the system and/or the method 9 uses the information from the bitstream, the system and/or the method 9 may determine on a per-block basis whether to use the motion vectors provided by the bitstream or to perform the motion estimation. Use of the motion vectors provided by the bitstream may reduce the computational complexity of the motion estimation for the block. In addition, the system and/or the method 9 may utilize a first test criterion to determine whether to use the motion vectors provided by the bitstream or to perform the motion estimation for the current block. The first test criterion may not require pixel operations and/or SAD computations. Thus, the system and/or the method 9 may be more efficient and/or may require less computation relative to known methods of interpolation.

If variable block sizes are used, the system and/or the method 9 may utilize the information from the bitstream to determine whether each 16×16 block should be split into smaller 8×8 blocks. Splitting each 16×16 block into smaller 8×8 blocks may provide better motion compensation for local areas which have complex motion. However, splitting each 16×16 block into smaller 8×8 blocks may increase the computational complexity of the motion estimation. The system and/or the method 9 may utilize a second test criterion to determine whether to split a 16×16 block into 8×8 blocks. The second test criterion may not require pixel operations and/or SAD computations. Thus, the system and/or the method 9 may be more efficient and/or may require less computation relative to known methods of interpolation.

As discussed previously, the system and/or the method 9 may use three interpolation paths to obtain three interpolated pictures that may be combined to remove artifacts. The forward interpolation path 10 may use unidirectional forward interpolation in that sample information from a previous original picture may be used to produce a forward interpolated image. The backward interpolation path 11 may use unidirectional backward interpolation in that sample information from the next original picture may be used to produce a backward interpolated image. The bidirectional interpolation path 12 may use bidirectional interpolation in that the sample information from the previous original picture and the sample information from the next original picture may be combined to produce a bidirectionally interpolated image.

The interpolation paths 10-12 may estimate motion between two temporally adjacent original pictures fₙ₋₁ and fₙ₊₁. The system may use the estimated motion with the two temporally adjacent original pictures fₙ₋₁ and fₙ₊₁ to generate a motion compensated interpolated picture fₙ temporally located halfway between the two temporally adjacent original pictures fₙ₋₁ and fₙ₊₁.

The picture used as reference for a block lattice and a direction of the motion vectors differs between the interpolation paths 10-12. As generally shown in FIG. 5, the bidirectional interpolation path 12 may use the interpolated picture as a reference grid for the block lattice. For the bidirectional interpolation path 12, the reference grid for the motion estimation may be located in the interpolated picture. Thus, the motion estimation for the bidirectional interpolation path 12 may produce one motion vector for each block in the interpolated picture.

As generally shown in FIG. 6, the forward interpolation path 10 may use the previous original picture fₙ₋₁ as the reference grid for the block lattice. The reference grid for motion estimation may be located in the next original picture fₙ₊₁. Thus, the motion estimation for the forward interpolation path 10 may produce one motion vector for each block in the next original picture fₙ₊₁.

The backward interpolation path 11 may use the next original picture fₙ₊₁ as the reference grid for the block lattice. The reference grid for motion estimation may be located in the previous original picture fₙ₋₁. Thus, the motion estimation for the backward interpolation path 11 may produce one motion vector for each block in the previous original picture fₙ₋₁.

The bidirectional interpolation path 12 may have an advantage that one motion vector may be found for each sample of the interpolated picture. Unidirectional interpolation such as that of the forward interpolation path 10 and/or the backward interpolation path 11 may have multiple motion vectors that overlap and/or missing motion vectors that form a hole for some samples of the interpolated picture. To address the overlap and/or the hole, a specialized motion compensation method may be employed as explained hereafter.

The system and/or the method 9 may employ any motion estimation method known to one skilled in the art. The present invention is not limited to a specific embodiment of the motion estimation. In a preferred embodiment, the motion estimation may be performed using Enhanced Predictive Zonal Search (“EPZS”). EPZS is known in the art and discussed in detail by Alexis M. Tourapis, “Enhanced predictive zonal search for single and multiple frame motion estimation,” in Proceedings of Visual Communications and Image Processing (VCIP '02), vol. 4671 of Proceedings of SPIE, pp. 1069-1079, San Jose, Calif., USA, January 2002, hereby incorporated by reference in its entirety. EPZS is described hereafter.

EPZS is a block-based motion estimation method designed to find one motion vector for each non-overlapping rectangular block of size N×N samples. As generally illustrated in FIG. 4, in a preferred embodiment of the present invention, the block size may be 8×8 or 16×16 depending on the mode of operation. If the picture has a size of W×H samples, a resulting block lattice may have a size of (W/N)×(H/N) such that a width and/or a height of the picture may be multiples of the block size. The motion field estimated by EPZS may be denoted as MFIELD and may be a 2 dimensional array of size (W/N)×(H/N). MFIELD[bx,by].MV may denote the motion vector of the block at lattice location [bx,by]. MFIELD[bx,by].SAD may denote the sum of absolute differences (“SAD”) of the block at lattice location [bx,by]. Block coordinates of [bx,by] may be in the ranges bx=0, 1, . . . , W/N−1 and by=0, 1, . . . , H/N−1 where [0,0] is the top left block and [W/N−1,H/N−1] is the bottom right block. For the estimation of the motion vectors, EPZS may utilize a motion field estimated during interpolation of the previous picture. The motion field estimated during interpolation of the previous picture may be denoted as MFIELD_N1. For the estimation of the motion vectors, EPZS may utilize a motion field estimated during interpolation of the picture located before the previous interpolated picture. The motion field estimated during interpolation of the picture located before the previous interpolated picture may be denoted as MFIELD_N2.

EPZS may use the SAD as block matching criterion. The system and/or the method 9 may calculate the SAD over a rectangular block of size N×N. Only luma samples may be used to calculate the SAD. The SAD is calculated depending on which one of the interpolation paths 10-12 is involved. For the forward interpolation path 10, the SAD may be calculated as follows:

$${SAD}_{fw} ( x , y , d ) = {\sum }_{i = x}^{x + N - 1} {\sum }_{j = y}^{y + N - 1} \vert {f}_{n + 1} ( [ \begin{matrix}i & {j ]}^{T} )\end{matrix} - {f}_{n - 1} ( [ \begin{matrix}i & {j ]}^{T} - d ) \vert\end{matrix} ,$$

where x=bx×N, y=by×N and d is a two-dimensional full sample precision motion vector.

For the backward interpolation path 11, the SAD may be calculated as follows:

$${SAD}_{bw} ( x , y , d ) = {\sum }_{i = x}^{x + N - 1} {\sum }_{j = y}^{y + N - 1} \vert {f}_{n - 1} ( [ \begin{matrix}i & {j ]}^{T} )\end{matrix} - {f}_{n + 1} ( [ \begin{matrix}i & {j ]}^{T} - d ) \vert\end{matrix} .$$

For the bidirectional interpolation path 12, the SAD may be calculated as follows:

$${SAD}_{bd} ( x , y , d ) = {\sum }_{i = x}^{x + N - 1} {\sum }_{j = y}^{y + N - 1} \vert {f}_{n - 1} ( [ \begin{matrix}i & {j ]}^{T} - d )\end{matrix} - {f}_{n + 1} ( [ \begin{matrix}i & {j ]}^{T} + d ) \vert\end{matrix}$$

The block lattice may be scanned in raster scan order, namely top-left to top-right and then down to a scan line below. For each block with coordinates [bx,by], the following operations may be performed to estimate the motion vector associated with the block.

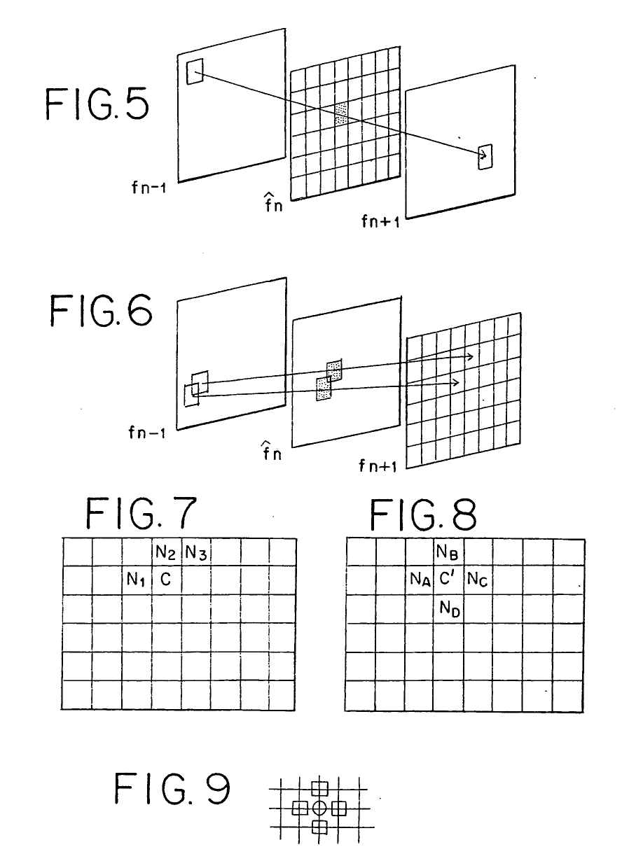

In a first operation of EPZS, the system and/or the method 9 may evaluate a median motion vector MV_MED calculated from motion vectors from neighboring blocks N1 . . . N3 in a causal neighborhood of the current block C, as generally illustrated in FIG. 7. The median motion vector may be calculated as MV_MED=vecmed(MFIELD[bx−1,by].MV, MFIELD[bx,by−1].MV, MFIELD[bx+1,by−1].MV), where vecmed denotes a vector median operation using a L1 norm as known in the art. If the SAD is lower than threshold T1, EPZS may terminate, and/or the system and the method 9 may use the median motion vector as a final motion vector for the current block: MFIELD[bx,by].MV=MV_MED and MFIELD[bx,by].SAD=SAD. The threshold T1 may be 64 for 8×8 blocks and/or may be 256 for 16×16 blocks. The threshold T1 may be adjusted to reduce the computational complexity of the motion estimation which may reduce quality of the motion estimation. The threshold T1 may be adjusted to increase the computational complexity of the motion estimation which may increase the quality of the motion estimation.

In a second operation of EPZS, the system and/or the method 9 may evaluate a second candidate set consisting of the following five motion vector candidates:
Zero motion vector (0,0)
MFIELD[bx−1,by].MV
MFIELD[bx,by−1].MV
MFIELD[bx+1,by−1].MV
MFIELD_N1[bx,by].MV

The candidate motion vector MFIELD[bx−1,by].MV, the candidate motion vector MFIELD[bx,by−1].MV and the candidate motion vector MFIELD[bx+1,by−1].MV may be the same motion vector candidates used to compute MV_MED in the first operation of EPZS stage and/or may correspond to N1 . . . N3 in FIG. 7. The candidate motion vector MFIELD_N1[bx,by].MV may be the motion vector estimated for the block having a corresponding location in the previously estimated motion field. The candidate motion vector MFIELD_N1[bx,by].MV may be computed and/or may be stored during computation of the previous interpolated picture.

If the lowest SAD computed from the five candidate motion vectors is less than threshold T2, the system and/or the method 9 may use a corresponding motion vector as the final motion vector for the current block. If the lowest SAD is less than the threshold T2, EPZS may terminate, and/or the system and/or the method 9 may store the SAD. The threshold T2 may be calculated as follows: T2=a×min(MFIELD[bx−1,by].SAD, MFIELD[bx,by−1].SAD, MFIELD[bx+1,by−1].SAD)+b. The constants may be established as a=1.2 and b=32 for 8×8 blocks. The constants may be established as=1.2 and b=128 for 16×16 blocks. Values of the constants may be adjusted to reduce the computational complexity of the motion estimation which may reduce quality of the motion estimation. Values of the constants may be adjusted to increase the computational complexity of the motion estimation which may increase the quality of the motion estimation.

In a third operation of EPZS, the system and/or the method 9 may evaluate a third candidate set consisting of the following 5 motion vector candidates:

MFIELD_N1[bx,by].MV+(MFIELD_N1[bx,by].MV−MFIELD_N2[bx,by].MV)
MFIELD_N1[bx−1,by].MV
MFIELD_N1[bx,by−1].MV
MFIELD_N1[bx+1,by].MV
MFIELD_N1[bx,by+1].MV

The first candidate motion vector MFIELD_N1[bx,by].MV+(MFIELD_N1[bx,by].MV−MFIELD_N2[bx,by].MV) may model constant acceleration. The other four candidate motion vectors may originate from blocks surrounding the block of corresponding location in the previously estimated motion field, as generally illustrated in FIG. 8. The third operation of EPZS may utilize the same adaptive threshold as used in the second operation of EPZS such that T3=T2. If the lowest SAD computed from the five candidate motion vectors is less than T3, the system and/or the method 9 may utilize the corresponding motion vector as the final motion for the current block. If the lowest SAD computed from the five candidate motion vectors is less than T3, EPZS may terminate, and/or the system and/or the method 9 may store the SAD.

If the system and/or the method 9 do not terminate EPZS in the previous three operations of EPZS, the system and/or the method 9 may execute a fourth operation of EPZS in which a refinement search may be performed using a EPZS small diamond pattern as generally illustrated in FIG. 9. An initial motion vector may be the candidate motion vector which resulted in the lowest SAD during the candidate considerations performed in the previous three operations of EPZS. The system and/or the method 9 may perform the refinement search iteratively. A result that corresponds to the lowest SAD may be implemented as a starting point of the next iteration. The system and/or the method 9 may stop the refinement search if the motion vector corresponding to the center of the pattern results in the smallest SAD. The system and/or the method may assign the motion vector and the corresponding SAD to MFIELD[bx,by].MV and MFIELD[bx,by].SAD, respectively.

In addition to EPZS, the system and/or the method 9 may also use motion vectors and/or macroblock information provided by the bitstream to reduce a number of block matching operations. The system and/or the method 9 may reduce the computational complexity of the motion estimation by reducing the number of block matching operations. The system and/or the method 9 may use the motion vectors and/or the macroblock information provided by the bitstream to change a block size to local motion complexity.

To reduce the computational complexity of the motion estimation, the system and/or the method 9 may use the motion vectors that are present in the bitstream being decoded. The motion vectors and/or the macroblock information may be used to produce the sequence of video frames being temporally upsampled and/or displayed. Hereinafter, use of the motion vectors and/or the macroblock information present in a video sequence compressed according to the H.264 standard is described. However, techniques described are applicable to other video compression algorithms and standards which make use of block-based motion estimation. The present invention is not limited to a specific video compression algorithm or standard and may be applied to motion information and/or macroblock information provided by any type of bitstream.

The video decoder may provide an application programming interface through which the system and/or the method 9 may obtain the motion vectors and/or the macroblock information from a decoded bitstream. Alternatively, a module associated with the system may parse the bitstream directly to obtain and/or provide the motion vectors and/or the macroblock information to the system and/or the method 9.

If the bitstream is a H.264 compressed video bitstream, a macroblock size of 16×16 luma samples may be used. The macroblock information may indicate a macroblock type for each macroblock. A macroblock of type INTRA is not associated with motion information. The video decoder may decode the macroblock of type INTRA using intra prediction and/or an encoded residual. A macroblock of type PTYPE is associated with one or more motion vectors. A number of the motion vectors may depend on the macroblock partition. For a H.264 compressed video bitstream, a macroblock of type PTYPE is a “P-Slice” macroblock or a “B-Slice” macroblock that are associated with at least one motion vector. A macroblock of type SKIP is not associated with a motion vector, but the motion vector may be calculated from motion vectors of neighboring blocks. The macroblocks of type SKIP are utilized for simple areas of the picture, such as, for example, stationary background.

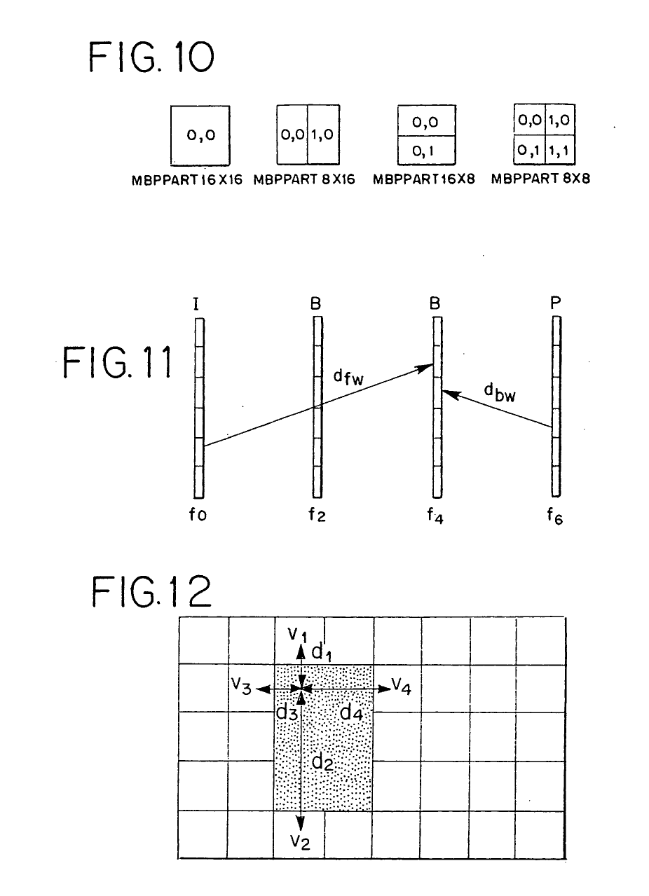

The macroblock information may indicate macroblock partitions. Video compression standards may support splitting of macroblocks into smaller sub-blocks. A separate motion vector may be used for each of the sub-blocks. In a preferred embodiment, the system and/or the method 9 may support four macroblock partitions that may be denoted MBPART16×16, MBPART8×16, MBPART16×8 and MBPART8×8, as generally illustrated in FIG. 10.

Each of the macroblocks present in the bitstream may be associated with one or more motion vectors. A number of the motion vectors may depend on the macroblock type, the macroblock partition and/or whether the video compression algorithm or standard supports bidirectional prediction. In a preferred embodiment, the system and/or the method 9 may support up to two motion vectors per sub-block. For example, a first motion vector may be oriented in a forward direction if a reference picture is the previous original picture, and a second motion vector may be oriented in a backward direction if a reference picture is the next original picture. In addition to the motion vector, a distance to the reference picture may be provided for each motion vector, as generally illustrated in FIG. 11. In FIG. 11, d_{fw} is a forward motion vector with a reference distance of two, and d_{bw} is a backward motion vector with a reference distance of one.

The motion vectors and/or the macroblock information obtained from the bitstream may be provided as a two-dimensional array of size (W/16)×(H/16) for each original picture decoded from the bitstream. In the following, the array is denoted as BSINFO[x,y,i] where x and y denote the spatial location of the macroblock and i denotes an index of the original picture. The index is incremented by two from a specific original picture to the next original picture which is consistent with FIG. 1. Each cell of the array may have the following elements:
BSINFO[x,y,i].TYPE {INTRA, PTYPE, SKIP}
BSINFO[x,y,i].PART {MBPART16×16, MBPART8×16, MBPART16×8, MBPART8×8}
BSINFO[x,y,i].MVFW[sx,sy]
BSINFO[x,y,i].MVFW_DIST[sx,sy]
BSINFO[x,y,i].MVBW[sx,sy]
BSINFO[x,y,i].MVBW_DIST[sx,sy]
   where MVFW[sx,sy], MVFW_DIST[sx,sy] may be the forward motion vectors and associated reference picture distances, and MVBW[sx,sy], MVBW_DIST[sx,sy] may be the backward motion vectors and associated reference picture distances. MVFW[sx,sy], MVFW_DIST[sx,sy], MVBW[sx,sy] and MVBW_DIST[sx,sy] may indicate corresponding reference distances for a sub-block with coordinates [sx,sy]. The sub-blocks may correspond to the macroblock partitions illustrated in FIG. 10.

For example, a macroblock of type PTYPE and PART=MBPART8×16 may have two sub-blocks. Each of the sub-blocks may be associated with motion vector information provided by MVFW, MVFW_DIST, MVBW and MVBW_DIST. A sub-block may have forward motion vector information, such as, for example, MVFW and MVFW_DIST; backward motion vector information, such as, for example, MVBW, MVBW_DIST; or both the forward vector information and the backward vector information. Alternatively, the sub-block may not be associated with motion vector information. The motion vector information associated with a sub-block may be determined by the video encoder during encoding of the bitstream.

If the mode of operation of the system and/or the method 9 is MODE_{—}8×8_BS, MODE_{—}16×16_BS or MODE_VAR, the motion vectors provided by the bitstream may be used during the motion estimation using EPZS. The system and/or the method 9 may use the motion vectors provided by the bitstream as a separate candidate set that may be tested before the first operation of EPZS that may test the median motion vector. The system and/or the method 9 may test whether the motion vector provided by the bitstream may be used for the current block as follows:

### If (MODE==MODE_{—}16×16_BS) OR (MODE==MODE_VAR):

If (BSINFO[bx,by,k].TYPE==SKIP):
   Use MV_BS as final motion vector for block
If (BSINFO[bx,by,k].PART==MBPART16×16) AND (|MV_BS−MV_MED|₁<=T_BS):
   Use MV_BS as final motion vector for block

### If (MODE==MODE_{—}8×8_BS):

If (BSINFO[floor(bx/2),floor(by/2),k].TYPE==SKIP):
   Use MV_BS as final motion vector for block
If (|MV_BS−MV_MED|₁<=T_BS):
   Use MV_BS as final motion vector for block
      where MV_MED may be the median motion vector as defined previously for the first operation of EPZS. The threshold T_BS may be set to a value which may result in less quality degradation relative to full motion estimation using EPZS, but may reduce the computational complexity. The computational complexity may be further reduced by increasing the threshold T_BS. However, increasing the threshold T_BS may decrease the visual quality of the upconverted sequence to less than when the motion vectors from the bitstream are not used. The variable k may determine from which original picture the macroblock information is obtained. For the motion estimation used to compute the forward interpolation path 10, k=n+1. For the motion estimation used to compute the backward interpolation path 11, k=n−1. In a preferred embodiment, the motion vectors provided by the bitstream are not used for the motion estimation for the bidirectional interpolation path 12.

The previously described techniques for determining reliability and/or usability of the motion vectors provided by the bitstream may be advantageous. For example, the system and/or the method 9 may not perform block matching operations, such as, for example, SAD operations, for blocks that use the motion vectors provided by the bitstream. Avoiding use of the block matching operations may reduce the computational complexity of the motion estimation relative to known upsampling methods. In addition, the previously described techniques may reject the motion vectors that do not correspond to true motion in the video sequence more reliably than methods that use SAD operations to calculate the reliability of the motion vectors obtained from the bitstream.

The motion vector MV_BS may be calculated from the bitstream as follows. For the motion estimation for the forward interpolation path 10, the motion in a forward direction from fₙ₋₁ to fₙ₊₁ may be estimated as using bitstream information BSINFO[x,y,n+1] provided by the next decoded original picture. Selection of x and y may be determined such that a location of the macroblock corresponds to the block for which the motion is estimated. If the block size is 16×16, such as in modes of operation MODE_{—}16×16_BS or MODE_VAR, for example, values of x and y may correspond to coordinates of the block for which the motion is estimated. For example, x=bx, y=by, sx=0 and/or sy=0. If the block size is 8×8, such as, for example, in the mode of operation MODE_{—}8×8_BS, macroblock coordinates and/or sub-block coordinates may be calculated as x=floor(bx/2), y=floor(by/2), sx=modulo2(bx) and/or sy=modulo2(by).

The motion vectors from the bitstream may be calculated as follows:

MV1=round(BSINFO[x,y,n+1].MVFW[sx,sy]/BSINFO[x,y,n+1].MVFW_DIST[sx,sy]),

MV2=(−1)×round(BSINFO[x,y,n+1].MVBW[sx,sy]/BSINFO[x,y,n+1].MVBW_DIST[sx,sy]).

If no motion vector is available in the forward direction, then MV1 may not be calculated. If no motion vector is available in the backward direction, then MV2 may not be calculated. Both MV1 and MV2 may be used as bitstream motion vectors as denoted by MV_BS above.

For the motion estimation for the backward interpolation path 11, the motion in the backward direction from fₙ₊₁ to fₙ₋₁ may be estimated as using bitstream information BSINFO[x,y,n−1] provided by the previous decoded original picture. The motion vectors from the bitstream may be calculated as follows:

MV1=round(BSINFO[x,y,n−1].MVBW[sx,sy]/BSINFO[x,y,n−1].MVBW_DIST[sx,sy]),

MV2=(−1)×round(BSINFO[x,y,n−1].MVFW[sx,sy]/BSINFO[x,y,n−1].MVFW_DIST[sx,sy]).

The mode of operation MODE_VAR may use block sizes of 16×16 and 8×8. The smaller 8×8 blocks may be used to represent local areas having complex motion. Adaptive block sizing to obtain the 8×8 blocks may be accomplished by using a block splitting stage of EPZS. In the block splitting stage, a 16×16 block may be split into four sub-blocks of size 8×8 such that each of the 8×8 sub-blocks may have a different motion vector.

For example, the mode of operation MODE_VAR may begin with 16×16 blocks. The system and/or the method 9 may execute the first operation of EPZS, the second operation of EPZS, the third operation of EPZS and/or the fourth operation of EPZS. The system and/or the method 9 may determine the reliability and/or the usability of the motion vectors provided by the bitstream as described previously. If EPZS did not terminate before the fourth operation of EPZS, the system and/or the method 9 may execute a “Block Splitting Decision” test as described hereafter to determine if the 16×16 block may be split into four 8×8 sub-blocks. If the system and/or the method 9 will not split the 16×16 block, then the system and/or the method 9 may terminate the motion vector search and/or may use the motion vector produced by EPZS for the current 16×16 block. If the system and/or the method 9 will split the 16×16 block, then the system and/or the method 9 may perform a sub-block motion vector refinement search for each 8×8 sub-block as described hereafter.

The “Block Splitting Decision” test may use the macroblock information provided by the bitstream. For the motion estimation in the forward direction, the system and/or the method 9 may use the following logic to determine if the block may be split:

If ((BSINFO[bx,by,n+1].TYPE==INTRA) OR (BSINFO[bx,by,n+1].PART !=MBPART16×16)): Split the block into 8×8 sub-blocks
Else: Terminate the motion vector search

A similar test may be employed for the motion estimation in the backward direction:

If ((BSINFO[bx,by,n−1].TYPE==INTRA) OR (BSINFO[bx,by,n−1].PART !=MBPART16×16)): Split the block into 8×8 sub-blocks
Else: Terminate the motion vector search

For the bidirectional motion estimation, the system and/or the method 9 may use the motion vector found by the fourth operation of EPZS which may be denoted as MV. Specifically, MV[0] may denote the x-component motion vector. MV[1] may denote the y-component motion vector. The system and/or the method 9 may use the following logic to determine if the block may be split:

xp=floor((bx×16−MV[0])/16)

yp=floor((by×16−MV[1])/16)

xn=floor((bx×16+MV[0])/16)

yn=floor((by×16+MV[1])/16)

If ((BSINFO[xp,yp,n−1].TYPE==INTRA) or (BSINFO[xp,yp,n−1].PART !=MBPART16×16) or (BSINFO[xn,yn,n+1].TYPE==INTRA) or (BSINFO[xn,yn,n+1].PART !=MBPART16×16)): Split the block into 8×8 sub-blocks
Else: Terminate the motion vector search

Thus, for the bidirectional motion estimation, the system and/or the method 9 may project the bi-directional motion vector MV into the previous decoded original picture and the next decoded original picture to select blocks corresponding to the previous decoded original picture and the next decoded original picture, respectively. The system and/or the method 9 may utilize the bitstream macroblock information corresponding to the selected blocks to determine whether to split the 16×16 block in the bidirectional interpolation path 12.

Use of the macroblock information provided by the bitstream may reduce computation required for determination of whether the block should be split. Further, use of the macroblock information provided by the bitstream may enable the system and/or the method 9 to utilize smaller blocks in the local areas having complex motion. Thus, the system and/or the method 9 may obtain a reliable block partitioning determination without a need to perform a computationally complex rate-distortion based optimization as typically performed by known video encoders.

If the “Block Splitting Decision” test results in a splitting of the 16×16 block into four 8×8 sub-blocks, the system and/or the method 9 may execute the sub-block motion vector refinement search for each of the 8×8 sub blocks. An initial motion vector for each of the 8×8 sub-blocks may be the motion vector found for the 16×16 block after the fourth operation of EPZS and/or denoted MV. A EPZS small diamond pattern as generally illustrated in FIG. 9 may be used for the sub-block motion vector refinement search. The system and/or the method 9 may repeat the sub-block motion vector refinement search iteratively for each of the 8×8 sub-blocks. The system and/or the method 9 may terminate the sub-block motion vector refinement search when the motion vector corresponding to the center of the EPZS small diamond pattern results in the lowest SAD.

In a preferred embodiment, the system and/or the method 9 may employ two different motion compensation operations. The motion compensation operation used may depend on which one of the interpolation paths 10-12 is involved. The bidirectional interpolation path 12 may use overlapped block motion compensation (“OBMC”) which may reduce blocking artifacts. The forward interpolation path 10 and/or the backward interpolation path 11 may project the estimated motion vectors into the interpolated picture to compute a dense motion field for the interpolated picture. The forward interpolation path 10 and/or the backward interpolation path 11 may implement a specialized motion compensation method to address situations where zero or multiple motion vectors may be associated with each sample of the interpolated picture.

Use of OBMC to reduce blocking artifacts is well known in the art. The system and/or the method 9 may employ OBMC using two different blending windows. The blending window used may depend on the block size. For 16×16 blocks, the blending window may be denoted w16×16 and/or may have a size of 24×24 samples. For 8×8 blocks, the blending window may be denoted w8×8 and/or may have a size of 16×16 samples. The two blending windows may be compatible to enable use of variable block sizes, such as, for example, 8×8 and 16×16, to be combined in the motion compensation. The blending windows may enable efficient calculation for the motion compensation. For example, the center of blending window w16×16 may be flat with value 1 so that no multiplications are necessary for the motion compensation of the blending window w16×16.

The blending window w16×16 may be calculated as follows:

$$w 1 [ u ] = \{ \begin{matrix} \frac{1}{8} ( u + \frac{1}{2} ) & for u = 0 … 7 , \\ 1 & for u = 8 … 15 , \\ w 1 [ 23 - u ] & for u = 16 … 23 ,\end{matrix}$$

w16×16[i,j]=w1[i]×w1[j], i=0 . . . 23, j=0 . . . 23

The blending window w8×8 may be calculated as follows:

$$w 2 [ u ] = \{ \begin{matrix} \frac{1}{8} ( u + \frac{1}{2} ) & for u = 0 … 7 , \\ w 2 [ 15 - u ] & for u = 8 … 15 ,\end{matrix}$$

w8×8[i,j]=w2[i]×w2[j], i=0 . . . 15, j=0 . . . 15

The system and/or the method 9 may scan the blocks in the raster scan order. For a block having a size N×N, where N may be

The system and/or the method 9 may scan the blocks in the raster scan order. For a block having a size N×N, where N may be 16 or 8, coordinates [bx,by] and previously estimated motion vector MV, the following operations may be performed:

$${x}_{0} = bx \times N$$

$${y}_{0} = by \times N$$

$$For {x}_{W} = 0 , 1 , … , N + 7$$

$$x = {x}_{0} + {x}_{W} - 4$$

$$For {y}_{W} = 0 , 1 , … , N + 7$$

$$y = {y}_{0} + yW - 4$$

$${\hat{f}}_{n}^{bd} ( {[ \begin{matrix}x & y\end{matrix} ]}^{T} ) = {\hat{f}}_{n}^{bd} ( {[ \begin{matrix}x & y\end{matrix} ]}^{T} ) + wN \times N [ {x}_{W} , {y}_{W} ] \times ( \begin{matrix}\frac{1}{2} {f}_{n - 1} ( {[ \begin{matrix}x & y\end{matrix} ]}^{T} - MV ) + \\ \frac{1}{2} {f}_{n + 1} ( {[ \begin{matrix}x & y\end{matrix} ]}^{T} + MV )\end{matrix} )$$

Before initiation of the motion compensation for a current bidirectional candidate interpolation picture, all samples of the bidirectional candidate interpolation picture fₙ^{bd} may be set to zero. For some of the samples, location [x t]^{t}−MV may be located outside of the sample lattice of the corresponding original picture, in which case the interpolated sample may be calculated by:

\hat{f}ₙ^{bd}([xy]^{T})=\hat{f}ₙ^{bd}([xy]^{T})+wN×N[x_{W},y_{W}]×fₙ₊₁([xy]^{T}+MV),

For some of the samples, location[x y]^{t}+MV may be located outside of the sample lattice of the corresponding original picture, in which case the interpolated sample may be calculated by:

\hat{f}ₙ^{bd}([xy]^{T})=\hat{f}ₙ^{bd}([xy]^{T})+wN×N[x_{W},y_{W}]×fₙ₋₁([xy]^{T}−MV),

the next decoded original picture may be combined using OBMC to produce a bidirectional candidate interpolation picture fₙ^{bd}.

The system and/or the method 9 may perform unidirectional motion compensation in the forward direction and/or the backward direction. The unidirectional motion compensation in the forward direction is described herein. Calculations of the unidirectional motion compensation in the backward direction may be obtained from calculations of the unidirectional motion compensation in the forward direction by exchanging fₙ₋₁ for fₙ₊₁.

The unidirectional motion compensation may utilize two 2-dimensional arrays DENSEMF and SAD. Both of the two 2-dimensional arrays DENSEMF and SAD may have dimensions W×H. The system and/or the method 9 may use the array DENSEMF to store a dense motion field in that each element of the array DENSEMF may hold a motion vector corresponding to a single sample of the unidirectional candidate interpolation picture. The system and/or the method 9 may use the array SAD to store a SAD value associated with the motion vector currently stored at the corresponding location in the array DENSEMF. A fixed block size of N×N is used hereinafter, although the present invention is not limited to specific block sizes. For example, the system and/or the method 9 may employ a similar method of unidirectional motion compensation to address variable block sizes, such as, for example, in the mode of operation MODE_VAR. For variable block sizes, block coordinates and/or block sizes may be calculated differently.

The system and/or the method 9 may calculate the unidirectional motion compensation in the forward direction as follows. The system and/or the method 9 may initialize SAD to large values where SAD[i,j]=INT_MAX for i=0 . . . W, j=0 . . . H. For each sample (x,y) in next decoded original picture, the system and/or the method 9 may project the motion vector to find location (x0,y0) in the interpolated picture. For each location and/or the method 9 may project the motion vector to find location (x0,y0) in the interpolated picture. For each location (x0,y0), the system and/or the method 9 may determine the projected MV with the lowest SAD.

For y=0, 1, . . . , H−1

For x=0, 1, . . . , W−1
MV_C=MFIELD.MV[floor(x/N), floor(y/N)].MV
SAD_C=MFIELD.MV[floor(x/N), floor(y/N)].SAD
x0=round(x−MV_C[0]/2)
y0=round(x−MV_C[1]/2)
If SAD_C<SAD[x0, y0]
DENSEMF_FW[x0, y0]=MV_C
SAD[x0, y0]=SAD_C

The system and/or the method 9 may use bilinear interpolation to provide motion vectors for any remaining locations (x,y) for which the above procedure did not associate a motion vector. The system and/or the method 9 may simultaneously complete computation of the bidirectional candidate interpolation picture as follows:

For y=0, 1, . . . , H−1

For x=0, 1, . . . , W−1
If SAD[x,y]==INT_MAX
   DENSEMF_FW[x,y]=interpolate(DENSEMF_FW, SAD, x,y)
MV_C=round(DENSEMF_FW[x,y]/2

$${\hat{f}}_{n}^{fw} ( {[ \begin{matrix}x & y\end{matrix} ]}^{T} ) = \frac{1}{2} {f}_{n - 1} ( {[ \begin{matrix}x & y\end{matrix} ]}^{T} - MV\_C ) + \frac{1}{2} {f}_{n + 1} ( {[ \begin{matrix}x & y\end{matrix} ]}^{T} + MV\_C )$$

INT_MAX may denote a number larger than the largest possible SAD value. As for the bidirectional motion compensation, location [x y]^{t}−MV or location [x y]^{t}+MV may be located outside of the sample lattice of the corresponding original picture, in which case the system and/or the method 9 may use only one original interpolate missing motion vectors. The function interpolate( ) may use the bilinear interpolation from the nearest available motion vector in a row direction and/or a column direction, as generally illustrated in FIG. 12.

The function interpolate( ) may be defined as follows: Function interpolate(DENSEMF, SAD, x, y)

| // MV and weight from below | |
|---|---|
| d = 0, d2 = 0 | |
| while ((d <= 5) AND (y + d < H)) | |
| if (SAD[x,y+d] != INT_MAX) | |
| v2 = DENSEMF [x,y+d] | |
| d2 = d | |
| break | |
| d = d+1 | |
| // MV and weight to the right | |
| d = 0 | |
| d4 = 0 | |
| while ((d <= 5) AND (x + d < W)) | |
| if (SAD[x+d,y] != INT_MAX) | |
| v2 = DENSEMF [x+d,y] | |
| d4 = d | |
| break | |
| d = d+1 | |
| // MV and weight from above | |
| if (y != 0) | |
| d1 = 1 | |
| v1 = DENSEMF [x,y−1] | |
| if (d2 == 0) | |
| d2 = d1 | |
| v2 = v1 | |
| else | |
| d1 = d2 | |
| 1 = v2 | |
| // MV and weight from to the left | |
| if (x != 0) | |
| d3 = 1 | |
| v1 = DENSEMF [x−1,y] | |
| if (d4 == 0) | |
| d4 = d3 | |
| v4 = d3 | |
| else | |
| d3 = d4 | |
| v3 = v4 | |
| // Handle special cases | |
| If ((d1 == 0) OR (d3 == 0)) | |
| If ((d1 ==0) AND (d3 == 0) | |
| Return [0,0] | |
| If (d1 == 0) | |
| // Only interpolation in row direction | |
| Return (d4*v3 + d3*v4)/(d3 + d4) | |
| If (d3 == 0) | |
| // Only interpolation in column direction | |
| Return (d2*v1 + d1*v2)/(d1 + d2) | |
| // Full interpolation | |
| Return | (d2*v1 + d1*v2)*(d3 + d4)/((d1 + d2)*(d1 + d2) + |
| | (d1 + d2)*(d3 + d4)) + |
| | (d4*v3 + d3*v4)*(d1 + d1)/((d3 + d4)*(d1 + d2) + |
| | (d3 + d4)*(d3 + d4)) |

Limiting the search range from the motion vector below and to the right to five samples may reduce the computational complexity without reduction of interpolation precision because weighting is inversely proportional to distance. It should be further noted that the bilinear interpolation function provided here is an example. Other suitable interpolation techniques are well known in the art and may be used instead of the bilinear interpolation function provided here. The present invention is here is an example. Other suitable interpolation techniques are well known in the art and may be used instead of the bilinear interpolation function provided here. The present invention is not limited to a specific embodiment of the bilinear interpolation function.

The system and/or the method 9 may employ two different artifact reduction methods. The system and/or the method 9 may apply a global artifact reduction. In the global artifact reduction, the system and/or the method 9 may estimate a quality of the interpolated picture using a SAD-based artifact counting process. If the estimated quality is considered insufficient, the system and/or the method 9 may implement frame repetition. If the estimated quality of the interpolated picture is considered sufficient, then the forward candidate interpolation picture fₙ^{fw}, the backward candidate interpolation picture fₙ^{bw} and the bi-directional candidate interpolation picture fₙ^{bd} (collectively hereinafter “the candidate interpolation pictures fₙ^{fw}, fₙ^{bw} and fₙ^{bd}”) may be combined using local artifact reduction. The system and/or the method 9 may apply chroma motion compensation to complete the interpolated picture fₙ.

The global artifact reduction may estimate the quality of the interpolation picture using the candidate interpolation pictures fₙ^{fw}, fₙ^{bw} and fₙ^{bd}. The global artifact reduction may estimate a magnitude of global motion. First, the candidate interpolation pictures fₙ^{fw}, fₙ^{bw} and fₙ^{bd} may be compared using a blockwise SAD operation. The blockwise SAD operation may use a block size of 8×8 and/or may be defined as:

$$SAD ( {f}^{a} , {f}^{b} , bx , by ) = {\sum }_{x = 8 xbx}^{8 x ( bz + 1 ) - 1} {\sum }_{y = 8 xby}^{8 x ( by + 1 ) - 1} \vert {f}^{a} ( {[ \begin{matrix}x & y\end{matrix} ]}^{T} ) - {f}^{b} ( {[ \begin{matrix}x & y\end{matrix} ]}^{T} ) \vert \\$$

The global artifact reduction may use the blockwise SAD operation to estimate a fraction of blocks that contain artifacts as follows:

as follows:

ARTIFACT_COUNT=0

For by=0, 1, . . . , H/8−1

For bx=0, 1, . . . , W/8−1

MIN_SAD=min(SAD(fₙ^{fw},fₙ^{bw},bx,by)

SAD(fₙ^{fw},fₙ^{bd},bx,by), SAD(fₙ^{bw},fₙ^{bd},bx,by))

If (MIN_SAD>T_ARTIFACT)

ARTIFACT_COUNT=ARTIFACT_COUNT+1

ARTIFACT_FRAC=ARTIFACT_COUNT/((W/8)*(H/8))

A value of T_ARTIFACT may be set as 500, but may be increased and/or decreased. A decreased value of T_ARTIFACT may result in more blocks labeled as containing artifacts which may result in a higher interpolation quality. However, more blocks labeled as containing artifacts may invoke unnecessary frame repetition which may reduce effectiveness of interpolation.

The system and/or the method 9 may obtain the global motion estimate from the block motion field of the forward interpolation path 10. Assuming a block size of N×N is used, the global motion may be estimated as:

$$MOTION = {‖ \frac{1}{( W / N ) \times ( H / N )} {\sum }_{bx = 0}^{W / N - 1} {\sum }_{by = 0}^{H / N - 1} MFIELD\_FW [ bx , by ] \cdot MV ‖}_{2}$$

The global artifact reduction may determine if the interpolation quality is insufficient as follows:

### If (MOTION>−T_MOTION)

If (ARTIFACT_FRAC>0.10)
Quality insufficient

### Else

If (ARTIFACT_FRAC>0.05)
Quality insufficient
   frame size, expected motion activity for a class of video content, experimental tuning and/or the like. A threshold for the fraction of blocks containing artifacts may also be adjusted. The global artifact reduction may use the typical values implemented in the previous calculation, namely 0.10 for global motion and 0.05 otherwise. Global motion may introduce artifacts which may be detected by the SAD-based artifact counting process but which may be less detectable and/or less objectionable to a human viewer. Thus, if the system and/or the method 9 detect global motion, a higher threshold may be implemented. The present invention is not limited to a specific embodiment of the threshold for the fraction of blocks containing artifacts.

If the system and/or the method 9 determine that the interpolation quality is insufficient, the system and/or the method 9 may implement frame repetition. Determination of the interpolation quality by the global artifact reduction may be implemented efficiently since the determination may be primarily based on SAD operations that may be computed in a small number of cycles by digital signal processors targeted for multimedia applications. In addition, the determination of the interpolation quality by the global artifact reduction may be more reliable than known methods which derive the interpolation quality from the smoothness of the motion field.

The global artifact reduction may detect scene changes. If a scene change is detected, the system and/or the method 9 may not obtain a usable interpolated picture temporally located between fₙ₋₁ and fₙ₊₁. Therefore, the system and/or the method 9 may implement frame repetition. If a scene change is detected, estimated motion vectors that precede the scene change may not be used for candidate prediction in the motion estimation by EPZS when estimating motion for interpolated images after the scene change. Therefore, the estimated motion vectors may be reset to zero for the candidate prediction in the motion estimation by EPZS.

If the bitstream provides the macroblock information, scene change detection may use the macroblock information provided by the bitstream. If the macroblock information is available, INTRA_FRAC may denote a fraction of macroblocks located in the next original picture fₙ₊₁ that are of type INTRA. The scene change detection may be performed as follows:

```
// Modes where bitstream information is not available
If ((MODE == MODE_8×8) OR (MODE == MODE_16×16))
    If (ARTIFACT_FRAC > 0.25)
        scene change
// Modes where bitstream information is available
If ((MODE == MODE_8×8_BS) OR (MODE == MODE_16×16_BS)
      OR (MODE == MODE_VAR))
    If ((ARTIFACT_FRAC > 0.25) AND (INTRA_FRAC > 0.65))
        scene change
```

A value of a first scene change detection threshold for the fraction of blocks containing artifacts may be set to 0.25 because scene changes may result in a large number of blocks containing artifacts. A value of the second scene change detection threshold for the fraction of macroblocks located in the next original picture fₙ₊₁ that are of type INTRA may be set to 0.65 because most macroblocks are of type INTRA after a scene change. The value of the second scene change detection threshold may not be sensitive in that scene change detection performance may not vary with changes in the value of the second scene change detection threshold.

Use of two scene detection thresholds may prevent incorrect determination of a scene change due to macroblocks of type INTRA present in frames not associated with a scene change. For example, macroblocks of type INTRA may be inserted for error resilience in wireless applications. As a further example, the bitstream may contain H.264 macroblocks of type IDR or macroblocks of type INTRA to provide random access points to the video stream. The H.264 macroblocks of type IDR and/or the macroblocks of type INTRA may be added at regular intervals to facilitate switching between channels in broadcast applications, such as, for example, DVB-H.

If a scene change is detected, the system and/or the method 9 may implement frame repetition. In addition, the motion fields that are used in EPZS in the interpolation paths 10-12 may be reset with zero motion vectors. The zero motion vectors may be necessary since a new scene may have different motion characteristics. A motion vector reset operation may be summarized as follows:

MFIELD_FW[x,y].MV=[0,0]

MFIELD_N1_FW[x,y].MV=[0,0]

MFIELD_N2_FW[x,y].MV=[0,0]

MFIELD_BW[x,y].MV=[0,0]

MFIELD_N1_BW[x,y].MV=[0,0]

MFIELD_N2_BW[x,y].MV=[0,0]

MFIELD_BD[x,y].MV=[0,0]

MFIELD_N1_BD[x,y].MV=[0,0]

MFIELD_N2_BD[x,y].MV=[0,0]

For x=0, 1, . . . , W/N−1 and y=0, 1, . . . , H/N

The system and/or the method 9 may reduce local artifacts using a median operation to combine the three candidate interpolation pictures into the final interpolated picture. Use of the median operation on a per sample basis may implement a majority determination scheme. For example, if two of the three interpolation paths 10-12 produce similar values for a specific sample, one of the similar values may be used for the final interpolated picture. Therefore, use of three different motion compensated interpolation pictures as input to the median operation may enable the system and/or the method 9 to correct erroneous motion estimates on the per sample basis which may result in improvement of the interpolation quality.

The local artifact reduction may use information from the median operation to perform the motion compensation for the chroma channels. In a preferred embodiment, the video sequence may use YCbCr 4:2:0 chroma subsampling. The system and/or the method 9 may denote the two chroma channels of a picture as ^{Cb}f and ^{Cr}f for a Cb channel and a Cr channel, respectively. The motion compensation for the chroma channels may use three motion fields. Each of the three motion fields may correspond to one of the three interpolation paths 10-12. The dense motion field DENSEMF_FW and the dense motion field DENSEMF BW may be the dense motion fields obtained during the unidirectional motion compensation in the forward interpolation path 10 and the backward interpolation path 11, respectively. The block motion field obtained by the motion estimation by EPZS in the bidirectional interpolation path 12 may be denoted as MFIELD_BD.

The system and/or the method 9 may perform the local artifact reduction and/or the motion compensation for the chroma channels as follows:

// For each position (x, y) in the interpolated image
For y=0,1, . . . , H−1

For x=0,1, . . . , W−1

// median filter selects which path to use
index = median_index (fₙ^{fw}([x y]^{t}),

(fₙ^{bw}( [x y]^{t}) , (fₙ^{bd}([x y]^{t}))

If (index = = 0)

fₙ([x y]^{t}) = fₙ^{fw}([x y]^{t})

If (index = = 1)

fₙ((x y]^{t}) = fₙ^{bw}([x y]^{t})

If (index = = 2)

fₙ([x y]^{t}) = fₙ^{bd}([x y]^{t})

// complete MC interp'n for subsampled chroma:
If ((modulo2 (x) = = 0) AND (modulo2 (y) = = 0))

fₙ([x y]^{t}) = fₙ^{bw}([x y]^{t} )

If (index = = 2)

fₙ([x y]^{t}) = fₙ^{bd([x y]}^{t})

// complete MC interp'n for subsampled chroma:
If ((modulo2 (x) = = 0) AND (modulo2 (y) = = 0))

xc = x / 2
yc = y / 2
If (index = = 0)

MV = round (DENSEMF_FW[x, y] / 4)

If (index = = 1)

MV = (−1) * round (DENSEMF_FW [x, y] / 4)

If (index = = 2)

MV = round (MFIELD_BD.MV[floor (x/N),
floor (y/N)] / 2)
${}_{}^{Cr}{f}{}_{n}^{} ( {[ xc yc ]}^{r} ) = \frac{1}{2} {}_{}^{Cr}{f}{}_{n - 1}^{} ( {[ xc yc ]}^{r} - MV ) + \frac{1}{2} {}_{}^{Cr}{f}{}_{n + 1}^{} ( {[ xc yc ]}^{r} + MV )$
${}_{}^{Cb}{f}{}_{n}^{} ( {[ xc yc ]}^{r} ) = \frac{1}{2} {}_{}^{Cb}{f}{}_{n - 1}^{} ( {[ xc yc ]}^{r} - MV ) + \frac{1}{2} {}_{}^{Cb}{f}{}_{n + 1}^{} ( {[ xc yc ]}^{r} + MV )$

The function median_index(a, b, c) may determine which input corresponds to the median. The function median_index(a, b, c) may be defined as follows:

Function median_index(a, b, c)

If (((b<=a) AND (a<=c)) OR ((c<=a) AND (a<=b))):
Return 0

If (((a<=b) AND (b<=c)) OR ((c<=b) AND (b<=a))):
Return 1

Return 2

At this point of the method 9, the final interpolated interpolation path 12. For a block at location [bx, by], the combined motion field may be obtained by vector median operation using a L1 norm as follows:
MFIELD_BD[bx, by].MV=vec_med(MFIELD_BD[bx, by].MV,
   DENSEMF_FW[bx×N+N/2, by×N+N/2]/2, (−1)×DENSEMF BW[bx×N+N/2, by×N+N/2]/2)

At the end of an interpolation cycle, the motion fields used by the motion estimation by EPZS may be rotated such that the current motion field becomes the previous motion field. Rotation may prepare the system and/or the method 9 for the motion estimation by EPZS for the next interpolated picture as follows:

MFIELD_N2=MFIELD_N1

MFIELD_N1=MFIELD

The rotation may be applied to the motion fields of the three interpolation paths 10-12.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A method for frame interpolation for a bitstream encoding a first source image and a second source image which is encoded subsequent to the first source image wherein a device receives the bitstream, the method comprising the steps of:
decoding the first source image and the second source image from the bitstream;
performing a first motion estimation which uses the first source image and the second source image to create a first motion field wherein the first source image is a reference grid for the first motion estimation;
performing a first motion compensation which uses the first motion field to create a forward candidate interpolation picture;
performing a second motion estimation which uses the first source image and the second source image to create a second motion field which is a different motion field than the first motion field wherein the second source image is a reference grid for the second motion estimation;
performing a second motion compensation which uses the second motion field to create a backward candidate interpolation picture;
performing a third motion estimation which uses the first source image and the second source image to create a third motion field which is a different motion field than the first motion field and the second motion field wherein a bidirectional candidate interpolation picture is a reference grid for the third motion estimation;
performing a third motion compensation which uses the third motion field to create the bidirectional candidate interpolation picture;
determining an estimated visual quality of a final interpolated picture formed by a combination of the forward candidate interpolation picture, the backward candidate interpolation picture and the bidirectional candidate interpolation picture; and
displaying the final interpolated picture if the estimated visual quality exceeds a threshold.

2. The method of claim 1 further comprising the step of:
applying a first sum of absolute difference operation to the forward candidate interpolation picture and the backward candidate interpolation picture, a second sum of absolute difference operation to the forward candidate interpolation picture and the bidirectional candidate interpolation picture, and a third sum of absolute difference operation to the backward candidate interpolation picture and the bidirectional candidate interpolation picture wherein results of the first sum of absolute difference operation, the second sum of absolute difference operation and the third sum of absolute difference operation are used to determine the estimated visual quality of the final interpolated picture.

3. The method of claim 1 further comprising the step of:
performing a median filtering operation for the forward candidate interpolation picture, the backward candidate interpolation picture and the bidirectional candidate interpolation picture wherein the median filtering operation combines the forward candidate interpolation picture, the backward candidate interpolation picture and the bidirectional candidate interpolation picture to produce the final interpolated picture.

4. The method of claim 1 further comprising the step of:
determining an estimated number of blocks in the final interpolated picture which are likely to have motion artifacts wherein the estimated number of blocks in the final interpolated picture which are likely to have motion artifacts is determined without combining the forward candidate interpolation picture, the backward candidate interpolation picture and the bidirectional candidate interpolation picture to produce the final interpolated picture and further wherein the estimated visual quality of the final interpolated picture is based on the estimated number of blocks in the final interpolated picture which are likely to have motion artifacts.

5. The method of claim 1 wherein at least one of the first motion estimation, the second motion estimation and the third motion estimation use enhanced predictive zonal search motion estimation.

6. The method of claim 1 further comprising the step of:
performing overlapped block motion compensation to at least one of the forward candidate interpolation picture, the backward candidate interpolation picture and the bidirectional candidate interpolation picture wherein the overlapped block motion compensation is performed in a corresponding one of the first motion compensation, the second motion compensation and the third motion compensation.

7. The method of claim 1 further comprising the step of:
using parameters encoded by the bitstream to determine whether to use motion vectors encoded by the bitstream in the first motion estimation and the second motion estimation for a block of one of the first source image and the second source image.

8. The method of claim 1 further comprising the step of:
using information encoded by the bitstream to determine whether to split a 16×16 block of one of the first source image and the second source image into smaller blocks for at least one of the first motion estimation, the second motion estimation and the third motion estimation wherein each of the smaller blocks is associated with a motion vector.

9. The method of claim 1 further comprising the step of:
using an estimate of a number of blocks of the final interpolated picture which are likely to have motion artifacts to determine a presence of a scene change wherein the forward candidate interpolation picture, the backward candidate interpolation picture and the bidirectional candidate interpolation picture are not combined to form the final interpolated picture if the presence of the scene change is determined.

10. The method of claim 1 further comprising the step of:
using frame repetition to extend display of the first source image before displaying the second source image if the estimated visual quality is below the threshold wherein the forward candidate interpolation picture, the backward candidate interpolation picture and the bidirectional candidate interpolation picture are not combined to form the final interpolated picture if the estimated visual quality is below the threshold.

11. The method of claim 1 further comprising the step of:
resetting at least one of the first motion field, the second motion field and the third motion field with zero motion vectors if an estimated number of blocks in the final interpolated picture which are likely to have motion artifacts does not meet a predetermined value.

12. The method of claim 1 further comprising the step of:
rotating at least one of the first motion field, the second motion field and the third motion field wherein rotating the at least one of the first motion field, the second motion field and the third motion field causes a current motion field to become a previous motion field and further wherein the first motion estimation, the first motion compensation, the second motion estimation, the second motion compensation, the third motion estimation and the third motion compensation are repeated using the motion fields which are rotated, the second source image and a third source image which is encoded subsequent to the second source image in the bitstream.

13. The method of claim 1 further comprising the step of:
performing chroma channel motion compensation on the final interpolated picture using the first motion field, the second motion field and the third motion field.

14. A method for frame interpolation for a bitstream encoding a first source image and a second source image subsequent to the first source image wherein the first source image and the second source image are formed by macroblocks and further wherein motion vectors are encoded by the bitstream wherein each of the macroblocks is associated with at least one of the motion vectors and further wherein the bitstream encodes block mode information wherein a device receives the bitstream, the method comprising the steps of:
determining reliable motion vectors of the motion vectors encoded by the bitstream wherein the motion vectors and the block mode information are used to determine the reliable motion vectors;
performing a first motion estimation which uses the first source image and the second source image to create a first motion field wherein the first source image is a reference grid for the first motion estimation and further wherein the first motion estimation uses the reliable motion vectors;
performing a first motion compensation which uses the first motion field to create a forward candidate interpolation picture;
performing a second motion estimation which uses the first source image and the second source image to create a second motion field which is a different motion field than the first motion field wherein the second source image is a reference grid for the second motion estimation and further wherein the second motion estimation uses the reliable motion vectors;
performing a second motion compensation which uses the second motion field to create a backward candidate interpolation picture;
performing a third motion estimation which uses the first source image and the second source image to create a third motion field which is a different motion field than the first motion field and the second motion field wherein a bidirectional candidate interpolation picture is a reference grid for the third motion estimation;
performing a third motion compensation which uses the third motion field to create the bidirectional candidate interpolation picture; and
displaying the first source image, the second source image and an interim image wherein the interim image is displayed after the first source image and before the second source image.

15. The method of claim 14 further comprising the steps of:
determining an estimated number of blocks in a final interpolated picture which are likely to have motion artifacts wherein the final interpolated picture is a combination of the forward candidate interpolation picture, the backward candidate interpolation picture, and the bidirectional candidate interpolation picture and further wherein the estimated number of blocks which are likely to have motion artifacts is determined without combining the forward candidate interpolation picture, the backward candidate interpolation picture, and the bidirectional candidate interpolation picture to produce the final interpolated picture;
identifying one of the final interpolated picture and a frame repetition of the first source image to use as the interim image wherein identification is based on the estimated number of blocks in the final interpolated picture which are likely to have the motion artifacts; and
forming the interim image wherein the interim image is formed using median filtering to combine the forward candidate interpolation picture, the backward candidate interpolation picture and the bidirectional candidate interpolation picture if the final interpolated picture is identified for use as the interim image and further wherein the interim image is formed using the frame repetition of the first source image if the frame repetition of the first source image is identified for use as the interim image.

16. The method of claim 14 further comprising:
determining whether to split blocks used in the first motion estimation and the second motion estimation into smaller blocks based on the block mode information encoded by the bitstream wherein each of the smaller blocks is associated with at least one of the motion vectors and further wherein the smaller blocks correspond to areas of increased density of the first motion field and the second motion field.

17. The method of claim 14 wherein the bitstream is a H.264 compressed video bitstream.

18. A system for frame interpolation for a bitstream encoding a first source image and a second source image, the system comprising:
a mobile device which receives the bitstream;
a processor connected to the mobile device which decodes the first source image and the second source image from the bitstream; and
an application executed by the mobile device which directs the processor to use the first source image and the second source image to generate at least three candidate interpolation pictures wherein the processor applies a sum of absolute difference operation to the at least three candidate interpolation pictures to estimate a number of blocks which are likely to have motion artifacts in a final interpolated picture formed by the at least three candidate interpolation pictures.

19. The system of claim 18 wherein the processor uses the number of blocks which are likely to have motion artifacts to determine a presence of a scene change between the first source image and the second source image and further wherein the processor does not form the final interpolated picture if the processor determines the presence of the scene change wherein the mobile device uses frame repetition in displaying the first source image before the second source image if the processor determines the presence of the scene change.

20. The system of claim 18 wherein the processor uses the number of blocks which are likely to have motion artifacts to estimate a visual quality of the final interpolated picture and further wherein the processor forms the final interpolated picture from the at least three candidate interpolation pictures if the visual quality estimated meets a threshold wherein the mobile device displays the first source image, the final interpolated picture and the second source image.

21. The system of claim 18 wherein the processor uses the number of blocks which are likely to have motion artifacts to estimate a visual quality of the final interpolated picture and further wherein the processor does not form the final interpolated picture if the visual quality estimated does not meet a threshold wherein the mobile device uses frame repetition to extend display of the first source image before displaying the second source image if the visual quality estimated does not meet the threshold.
